(19) United States
(12) Patent Application Publication
(10) Pub. No.: US 2006/0151473 A1
(43) Pub. Date: Jul. 13, 2006

(54) Aquarium thermostat controller

(76) Inventor: Wen-Hong Su, Tucheng City (TW)

Correspondence Address: LEONG C LEI, PMB # 1008, 1867 YGNACIO VALLEY ROAD, WALNUT CREEK, CA, 94598, US

(21) Appl. No.: 11/026,048

(22) Filed: Jan. 3, 2005

(51) Int. Cl. H05B 1/02

(52) U.S. Cl. 219/506

(57) ABSTRACT

A thermostat controller to maintain optimal water temperature in an aquarium includes a single chip to constantly check if the temperature at the input maintains at the preset level and to regulate output signals; a sensor to detect temperature and transmit detected signals to the single chip; an electric heating device subject to the control by output from the single chip; a display to indicate temperature, and an alarm to warn abnormality.

### BACKGROUND OF THE INVENTION

(a) Technical Field of the Invention

The present invention is related to an aquarium thermostat controller, and more particularly to one maintains the optimal temperature of the aquarium or similar structures.

(b) Description of the Prior Art

Fish is a cold-blooded animal, meaning each species of the fish has its limits to bear the water temperature in its habitat and feels most comfortable at an optimal temperature. Within the range of the optimal temperature, fish is able to maintain vigorous mechanism in taking food, breathing, and digestion, improve metabolism, and grow fast. When the temperature in an aquarium or similar structure used to raise pet fish is not controlled to fall within the range of the optimal temperature, the fish suffers poor metabolism, inhibited growth, and even death.

The population of fish lovers is comparatively large around the world and the fish species varies depending on the circle of celestial sphere, i.e., Frigid Zone, temperate zone, the subtropical zone, or tropical zone. The temperature in the aquarium in the summer, particularly the ambient temperature will not cause the temperature in the aquarium getting to high. Generally, it's the wintertime for the owner to get worried. To prevent drastic drop of the water temperature in the aquarium, the owner usually mount a heater to raise the water temperature. However, the owner has to always watch for the temperature reading to decide whether the heater will be activated or not. Later the introduction of an electronic heater that automatically detects the water temperature to turn on or off the heater as required.

### SUMMARY OF THE INVENTION

The primary purpose of the present invention is to provide a thermostat controller for the aquarium to maintain the optimal water temperature therein. To achieve the purpose, the present invention includes a single chip to constantly check if the temperature at the input maintains at the preset level and to regulate output signals; a sensor to detect temperature and transmit detected signals to the single chip; an electric heating device subject to the control by output from the single chip; a display to indicate temperature, and an alarm to warn abnormality.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a detailed schematic of a preferred embodiment of the present invention.

FIG. 2 is a front view of the preferred embodiment of the present invention in a box.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

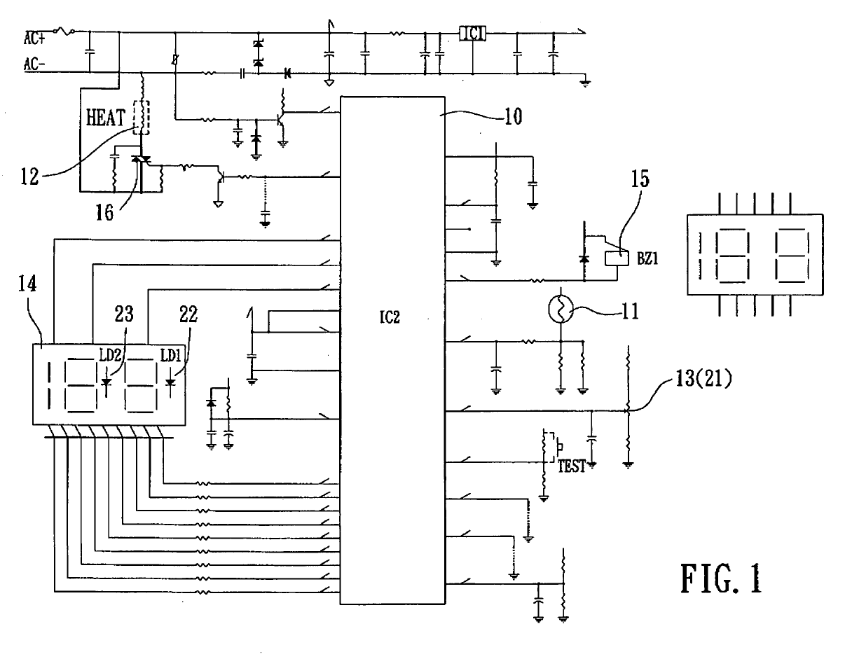

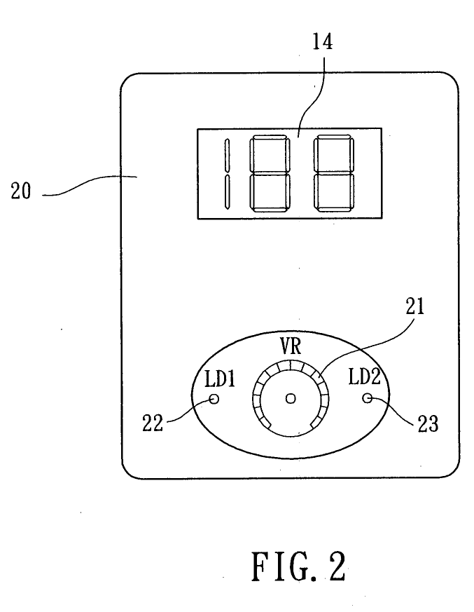

Referring to FIGS. 1 and 2, the present invention includes a control box 20 of control circuit connected to a sensor 11 and a heater 12. The control circuit in the control box 20 contains multiple resistances, capacitors, diodes, and transistors, a two-way gate throttle, an IC, a single chip 10, a sensor 11, an electric heater 12, a variable resistance 13, a display 14, and a buzzer. The variable resistance 13 is connected to an adjustment knob 21 provided externally to the control box 20, and the adjustment knob 21 is connected to a red LED 22 and a green LED 23.

There are two ranges of temperature preset by the present invention, respectively, 20° C.˜35° C. and 10° C.˜50° C. The display range of the display 14 is 020 C.˜50° C. with an error of 0.5° C. or 0.5° F. Turning the adjustment knob 21 sets the temperature, and both LEDs (22, 23) are lighted at the same time during the setup. When the heater is active, the red LED 22 is on, and when the water temperature reaches its preset value, the green LED 23 is on. The heater 12 is protected by 15 seconds of ON and OFF delay during the heating process and at the time reaching the preset temperature.

Once the sensor 11 detects shortage/cut-off in the circuit, or the difference between then current water temperature and the preset temperature is 3° C. or greater, the display 14 flares and the buzzer 15 sounds off to alert the owner. In the initial use of the present invention, the display 14 flares at a cycle of On for 0.5 seconds and Off for 0.5 seconds (at the frequency of 1 Hz), and stops flaring after five seconds while indicating the water temperature. While the display 14 is flaring, both LEDs (22, 23) also flare at the same time. Once the heater starts to heat up the water in the aquarium and the water temperature is equal or higher than that of the preset temperature, the heater 12 is switched off, the red LED is off and the green LED 23 is on. If the water temperature is below the preset temperature, the heater 12 is activated, the red LED 22 is lighted, and the green LED 23 is off.

Turning the adjustment knob 21 is taken as the motion to set up the temperature. During the temperature setup, both LEDs (22, 23) flare simultaneously. In the temperature controlled ΔT=ts−tw (wherein, ts: preset temperature, and tw: water temperature), If 0≦ΔT<1, the two-way gate throttle operates at a power of 10%; 1≦ΔT<2, 20%; 2≦−ΔT<3, 30%; . . . ; and 8≦ΔT<9, 90% until ΔT≧9, the two-way gate throttle operates at 100% power. In the initial use of the present invention, the operation power is selected as the way described above for the heater 12 (the value is recorded). In case of failure to reach the preset temperature within 30 minutes, add 10% power for the operation. When ΔT=ts−tw≦0 (servo operation), the control box 20 operates with the memorized setting in the following patterns:
(1) There will be 15 second-on/off delay for the heater 12;

(2) If the water temperature reaches the preset value less than five minutes, the control box 20 executes servo operation in the fashion of “memorized setting minus 10%”;
(3) If the water temperature reaches the preset value exactly after five minutes, the control box 20 executes servo operation in the fashion of “memorized setting plus 10%” and repeats (2).

In the initial power on to use the present invention, the alarm function is not available until the condition of the difference between the water temperature and the preset temperature is not equal to 0° C. The sensor 11 shortage/cut-off protection and alarm function are as follows:
(a) In case of cut-off, the display 14 flares and the buzzer 15 sounds off at the frequency of two times with one interruption.
(b) In case of a shortage, the display 14 flares and the buzzer 15 sounds off at the frequency of three times with one intermission.

When the water temperature is not lower than 30° C.˜51° C., the red LED 22 flares, the buzzer 15 sounds, and the display 14 indicates then current water temperature. When the difference between the water temperature and the preset temperature is equal or greater than 3° C., the display 14 and the buzzer 15 respectively flares and sounds for five times with one intermission, or six times with one intermission in case of poor contact of the adjustment knob 21 (the variable resistance 13). While the display 14 flares and the buzzer 15 sounds, the sensor 11 stops detecting the water temperature and the heater 12 is switched OFF. All the flaring alert and the alarm functions are discontinued when the water temperature is back to normal.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-2. (canceled)

3. A thermostat controller comprising:
a single chip;
a sensor electrically connected to said single chip;
a triac electrically connected to said chip;
a heater electrically connected to said single chip;
a variable resistor electrically connected to said single chip;
a display electrically connected to said single chip; and
a heater electrically connected to said single chip;
wherein said single chip is set to control temperature according to a formula: ΔT=ts−tw (wherein ts represents preset temperature and tw water temperature), so that 0≦ΔT≦9 or ΔT≧9 is a comparative value and said single chip will automatically select different power input at a preset percentage for said heater via said triac according to the comparative value thereby controlling said heater to increase temperature gradually.

4. The thermostat controller as claimed in claim 3, wherein said single chip is connected with a warning device which is a buzzer.

5. The thermostat controller as claimed in claim 3, wherein said heater is externally connected to said single chip.

6. The thermostat controller as claimed in claim 3, wherein when 0≦ΔT<1, said triac will operate at 10% of maximum power; when 0≦ΔT<2, said triac will operate at 20% of maximum power; when 0≦ΔT<3, said triac will operate at 30% of maximum power; when 0≦ΔT<4; said triac will operate at 40% of maximum power; when 0≦ΔT<5, said triac will operate at 50% of maximum power; when 0≦ΔT<6, said triac will operate at 60% of maximum power; when 0≦ΔT<7, said triac will operate at 70% of maximum power; when 0≦ΔT<8, said triac will operate at 80% of maximum power; when 0≦ΔT<9, said triac will operate at 90% of maximum power; when ΔT≧9, said triac will operate at 100% of maximum power.
